(19) United States
(12) Patent Application Publication
(10) Pub. No.: US 2016/0142244 A1
(43) Pub. Date: May 19, 2016

(54) MOBILE COMPUTING DEVICE AND APPLICATION CONFIGURING SAME TO RAPIDLY PROVISION AND MONITOR SERVICES AND REDUNDANCY IN A NETWORK

(71) Applicant: Transition Networks, Inc., Minnetonka, MN (US)

(72) Inventors: Anita Kumar, Edina, MN (US); James C. Maki, St. Francis, MN (US)

(21) Appl. No.: 14/943,304

(22) Filed: Nov. 17, 2015

Related U.S. Application Data
(60) Provisional application No. 62/080,988, filed on Nov. 17, 2014.

(51) Int. Cl. H04L 12/24

(52) U.S. Cl. CPC H04L 41/046; H04L 41/0246; H04L 41/0668; H04L 41/0677; H04L 41/0853; H04L 41/0883; H04L 41/22

(57) ABSTRACT

Disclosed embodiments include applications, computing devices configured with the applications, and computer implemented methods to manage, set-up, configure and/or monitor Ethernet Virtual Private Line services.

### BACKGROUND OF THE INVENTION

This application claims the benefit of U.S. Provisional Application No. 62/080,988, filed Nov. 17, 2014.

The present invention relates to the provisioning of Ethernet Virtual Private Line services and Ethernet Ring Protection Switching.

Configuring of devices in a network can be a complex, time consuming and error prone task. For example, configuring a standard, reliable Ethernet Virtual Private Line service between two endpoints can involve setting up to twenty individual settings on each endpoint. Additionally, there are Ethernet ring devices to configure as well. For instance, configuring G.8032 Ethernet Ring Protection Switching, for redundancy, can involve setting up to seventeen individual settings on each device in the ring which in a minimum three-device ring will mean fifty one individual settings. As the ring grows, the number of settings for a field technician can be come overwhelming, to say the least.

For instance, for a field technician to configure end points and a ring manually without any errors is a daunting task, and the task is even more overwhelming considering that field technicians may wish to rely on mobile devices with smaller screens and limited input/output tools. The limitations of mobile devices generally prohibit use of mobile devices for such tasks. To add on to the hurdle, when remotely configuring an Ethernet Virtual Private Line service, a connection between the field device and the management server may be lost intermittently causing a further strain on accuracy. Additionally, even with successful completion of the task of an initial configuration of an Ethernet Virtual Private Line service remotely, it appears that it is common that updates to the service are frequently needed. Updates to such a service is by no means an easy task, especially when an update includes adding multiple end points, switch devices, and even demarcation nodes. With the complexity of initial configurations and frequent updates, the aforementioned tasks can be very time consuming. This is especially the case when the technician has little experience with Ethernet Virtual Private Line services.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter.

Example embodiments may include methods of providing an interactive view of a configured Ethernet Virtual Private Line (EVPL) over a wireless network to a remote technician computer. Such methods may include controlling, at a management server, at least part of an EVPL viewer application installed on the remote technician computer. The application may include a graphical user interface (GUI) that displays the view of the EVPL and an Ethernet ring associated with the EVPL. Such methods may also include receiving EVPL data at the management server sent from demarcation devices of the EVPL and identifying links that are operational or failing and links in the Ethernet ring that provide failover, according to the EVPL data. The example methods may also include generating a failing link alert including an indication of a failing link and a failover link in the Ethernet ring, based on the identified links and transmitting the alert over the wireless network to the remote technician computer according to a request from the remote technician computer. The transmitted alert may activate the application to cause the alert to display on the remote technician computer.

In some of the example methods, the EVPL data may be configured such that the failover link provides the failover and private communications can occur between terminal devices communicatively coupled to the demarcation devices.

In some of the example methods, the management server may include a processor that performs the identifying of the links and generating of the failing link alert. In such examples, the management server may also include memory that stores the EVPL data that includes operational status and network topology information of the demarcation devices and the Ethernet ring including which links in the Ethernet ring provide failover and which links are operational or failing.

In some of the example methods, the demarcation devices of the EVPL are linked to each other and the Ethernet ring over communication paths of a service providing network providing the EVPL.

In some of the example methods, the demarcation devices include a first user-network interface (UNI) and a second UNI associated with the EVPL.

In some of the example methods, the demarcation devices include a first network interface device (NID) and a second NID associated with the EVPL.

In some of the example methods, each of the demarcation devices stores its respective EVPL data in its respective flash memory device.

In some of the example methods, the service providing network includes local area network based communication paths, Internet or intranet based communication paths, dedicated communication paths, wireless communication paths, or any combination thereof.

In some of the example methods, the management server transmits the failing link alert over the wireless network to the remote technician computer according to an application program interface (API) of the management server and the request from the remote technician computer.

In some of the example methods, the request includes an IP address of the management server.

In some of the example methods, the request includes configuration information associated with the demarcation devices.

In some of the example methods, the request includes configuration information associated with switch devices of the Ethernet ring. In such examples, the configuration information associated with the switch devices can include an indication of which of the switch devices are to be linked to provide failover. Also, the indication of which of the switch devices are to be linked to provide failover can include a sensed gesture on a touchscreen communicatively coupled to the remote technician computer. Further, the sensed gesture can include a swipe, over the GUI, between visual representations of the switch devices to be linked to provide failover. Also, the sensed gesture can include a drag, over the GUI, between visual representations of the switch devices to be linked to provide failover.

Example embodiments may also include computer-implemented methods for providing an interactive view of a configured Ethernet Virtual Private Line (EVPL) in a graphical user interface (GUI) of a remote technician computer. Such methods may include displaying, by the remote computer, a visual representation of the EVPL in the GUI, and displaying an EVPL configuration interface in the GUI. The methods may also include receiving EVPL configuration input via the displayed configuration interface. Also, the methods may include monitoring, by the remote computer, the EVPL via a management server, according to requests it sends to the management server. In such examples, the requests can include the EVPL configuration input. The methods may also include receiving, by the remote computer, a failing link alert transmitted from the management server. In such examples, the alert may be based on status of aspects of the EVPL and the EVPL configuration input. The methods may also include automatically updating the visual representation of the EVPL to include the received alert.

In some of the example methods, the visual representation of the EVPL can include visual representations of aspects associated with the EVPL, including an Ethernet ring, demarcation devices, and a failover link in the Ethernet ring.

Example embodiments may also include systems useful to a service provider serving an interactive view of a configured Ethernet Virtual Private Line (EVPL) over a wireless network to a remote technician computer. Such example systems may include a computer store containing EVPL data, for the EVPL, defining operational status and network topology information associated with the EVPL, which links in an Ethernet ring associated with the EVPL provide failover, and which links in the EVPL are operational or failing. The example systems may also include a computer server at the service provider. The computer server can be communicatively coupled to the computer store. The computer server can also be programmed to receive EVPL data from the computer store and control at least part of an EVPL viewer application installed on the remote technician computer. In such examples, the application can include a graphical user interface (GUI) that displays a view of the EVPL and the Ethernet ring. The control of the least part of the EVPL viewer application can include identifying links that are operational or failing and the links in the Ethernet ring that provide failover. The control can also include generating a failing link alert including an indication of a failing link and a failover link in the Ethernet ring, based on the identified links. Also, the control can include transmitting the alert over the wireless network to the remote technician computer according to a request from the remote technician computer.

In some of the example systems, the request from the remote technician computer can include configuration information associated with switch devices of the Ethernet ring and an indication of which of the switch devices are to be linked to provide failover. In such examples, the indication of which of the switch devices are to be linked to provide failover can include a sensed gesture on a touchscreen communicatively coupled to the remote technician computer.

Disclosed embodiments include applications, computing devices configured with the applications, and computer implemented methods to manage, set-up, configure and/or monitor Ethernet Virtual Private Line services.

### BRIEF DESCRIPTION OF THE DRAWINGS

FIG. 1 is a block diagram illustrating an example embodiment of a computing device configured in accordance with exemplary embodiments.

FIG. 2 is a block diagram of a system for configuring Ethernet Virtual Private Line services.

FIGS. 3-12 are diagrammatic illustrations of graphical user interface screens generated by an application using the computing device of FIG. 1 to monitor or configure Ethernet Virtual Private Line services and Ethernet Ring Protections switching.

FIG. 13 illustrates example operations performed by an example management system server in communication with an example mobile computing device.

FIG. 14 illustrates example operations performed by an example mobile computing device in communication with an example management system server.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Exemplary embodiments of the disclosed invention preferably include, and operate to configure, a computer such as a tablet computer, a mobile computing device such as a smart phone, a laptop computer, a desktop computer, or other computing devices, particularly computing devices having a touch screen input graphical user interface. The exemplary embodiments include computer implemented methods, computer readable instructions, and configured computing devices which facilitate communication with a management system to configure devices to provide Ethernet Virtual Private Line services to a service recipient from a service provider. In examples, an Ethernet Virtual Private Line (EVPL) service can include a dedicated connection between at least two user-network interfaces (UNIs).

To address the problem of a field technician not having the training, education and/or skill level of a network administrator to enable the technician to configure, manage and monitor EVPLs, disclosed embodiments provide an application and a graphical user interface (GUI) which allows a field technician to configure EVPL services, or similar services, with almost no knowledge of the complex technology that is being configured.

Only the few attributes may be known to the field technician: the name of the device at a customer site, the port on the device that is being used for the customer, any tags on the customer traffic, how much bandwidth the customer is purchasing, and a service provider tag for that customer's traffic, which may be required to be entered to configure the service.

Similarly, for configuring the Ethernet Ring Protection switching for sub-50 ms failover, the field technician only needs to enter information about the link which will be the redundant link by providing the owner and neighbor information of that link. No other information is needed to set up this very complex configuration.

The application provides an intuitive, easy to use GUI. Gestures allow dragging between two end points, intermediate nodes, and switches within a ring, to create a service. To enable ring protection, gestures allow dragging along the link to identify a link to be configured as the Ring Protection Link (RPL). Once a service is configured, the application provides an easy to understand view of the configured service and the RPL. If there is a link failure, the application updates the view of the service to show that traffic has failed over to the protected link.

Although not required, the invention is described in the general context of computer-executable instructions, such as program modules or applications, being executed by an electronic device such as a tablet computer or other computing device. Generally, program modules include routines, programs, objects, components, data structures, etc. that perform particular tasks or implement particular abstract data types. In embodiments, the invention may be practiced in distributed computing environments where tasks are performed by remote processing devices that are linked through a communications network. In a distributed computing environment, program modules may be located in both local and remote memory storage devices.

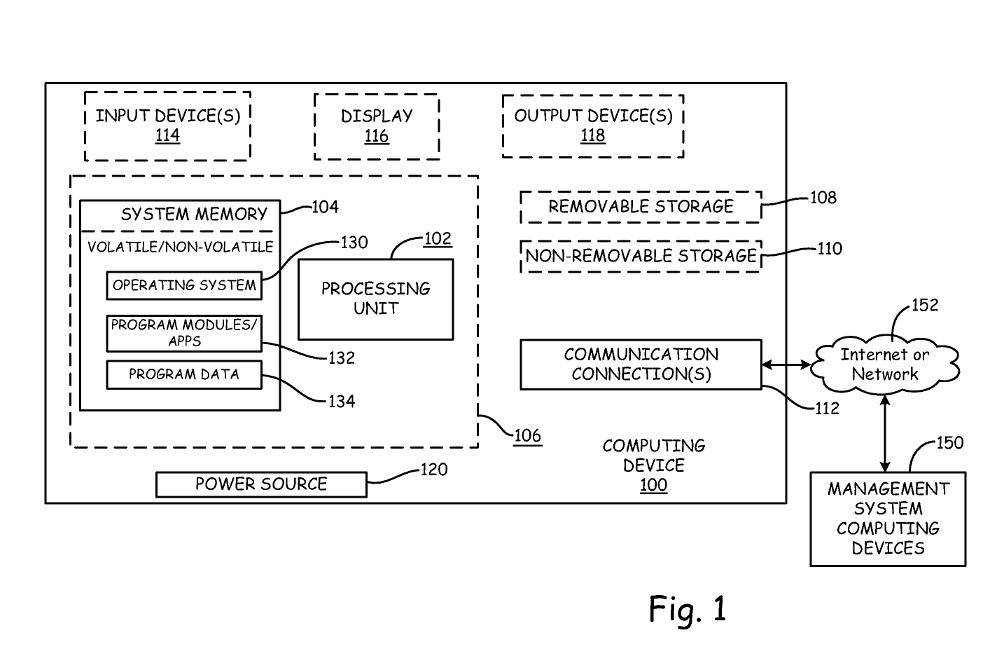

FIG. 1 shows an exemplary device 100 for implementing an embodiment of the invention. While in exemplary embodiments, device 100 is a tablet type of computer, device 100 can be other types of computers and is therefore described in the context of a general computing device. In a basic configuration, the computing device 100 includes at least a processing unit 102 and a memory 104. Depending on the exact configuration and type of computing device, the memory 104 may be volatile (such as RAM), non-volatile (such as ROM, flash memory, etc.) or some combination of the two. This example configuration is illustrated in FIG. 1 by a dashed line 106.

Additionally, the device 100 may also have additional features and functionality. For example, the device 100 may also include additional storage (removable and/or non-removable) including, magnetic or optical disks or tapes, USB flash drives, memory cards, etc. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can be accessed by the device 100. Any such computer storage media may be part of the device 100.

In the description that follows, the invention will be described with reference to acts and symbolic representations of operations that are performed by one or more devices, unless indicated otherwise. As such, it will be understood that such acts and operations, which are at times referred to as being computer-executed, include the manipulation by the processing unit of the device of electrical signals representing data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in specific hardware such as an application-specific integrated circuit (ASIC).

System memory 104 may include operating system 130, one or more programming modules or applications 132, and program data 134. Operating system 130, for example, may be suitable for controlling computing device 100's operation. As stated above, a number of program modules 132 and data files 134 may be stored in system memory 104, including operating system 130. While executing on processing unit 102, programming modules or applications 132 may perform processes including, for example, one or more methods described below, using one or more of the GUI screens or windows shown and described.

Generally, consistent with disclosed embodiments, program modules or applications may include routines, programs, components, data structures, and other types of structures that may perform particular tasks or that may implement particular abstract data types. Moreover, disclosed embodiments may be practiced with other computer system configurations, including multiprocessor systems, microprocessor-based or programmable consumer electronics, minicomputers, mainframe computers, ASICs, and the like. Disclosed embodiments may also be practiced in distributed computing environments where tasks are performed by remote processing devices that are linked through a communications network. In a distributed computing environment, program modules may be located in both local and remote memory storage devices.

Furthermore, some disclosed embodiments may be practiced in an electrical circuit comprising discrete electronic elements, packaged or integrated electronic chips containing logic gates, a circuit utilizing a microprocessor, or on a single chip containing electronic elements or microprocessors. Some disclosed embodiments may also be practiced using other technologies capable of performing logical operations such as, for example, AND, OR, and NOT, including but not limited to mechanical, optical, fluidic, and quantum technologies. In addition, some disclosed embodiments may be practiced within a general purpose computer or in any other circuits or systems.

Disclosed embodiments, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the disclosed embodiments may be embodied in hardware and/or in software (including firmware, resident software, micro-code, etc.). In other words, some disclosed embodiments may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain, store, communicate, propagate, or transport the program for use by or in connection with the instruction execution system, apparatus, or device.

The device 100 may also contain one or more communications connections 112 that allow the device to communicate with other devices. The communications connections 112 can include, for example, wired media connections such as a wired network or direct-wired connection, and wireless media connections such as acoustic, RF, infrared and other wireless media connections. In exemplary embodiments, communications connections 112 are configured to provide communication between device 100 and a management system computing device 150 over a computer network 152 such as the Internet. Connection to the computer network can include wireless communication, cellular data communication, and/or any other type of connection. In some exemplary embodiments in which device 100 is a tablet computer, instead of communication connections 112 connecting directly to Internet or network 152, communication connections 112 can include one or both of USB communication circuitry and wireless communication circuitry for communicating through network routers and other server computers which provide the connection to the Internet or other computer network 152.

In exemplary embodiments the computing device 100 has, or can be coupled to, a touch screen display device 116 which provides a touch based GUI. The device 100 may also have, or be coupled to, one or more input devices 114, such as a keyboard, mouse, pen, voice input device, etc., for providing other input to the computing device. The device 100 may be coupled to one or more other output devices 118 such as speakers, a printer, a vibration generator, etc. All these devices are well known in the art and need not be discussed at greater length here. Further, display device 116, input devices 114 and output devices 118 can all be considered to be separate from, or alternatively part of, computing device 100. Display device 116, input devices 114 and output devices 118 are also not required in all embodiments.

Computing device 100 can be provided with a portable or non-portable power source 120, such as a battery pack, a transformer, a power supply, or the like. The power source 120 provides power for computations, communications and so forth by the device 100.

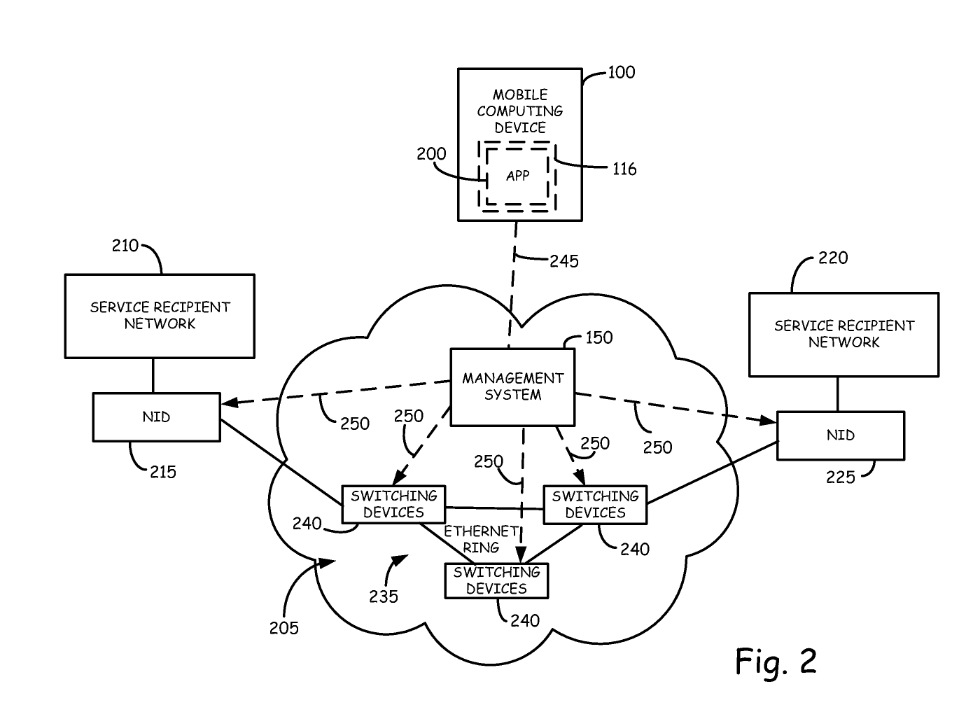

Referring now to FIG. 2, shown is computing device 100 having display device 116, for example a touch screen display device of a tablet computer, with the processing unit 102 of computing device 100 configured with an exemplary application 200 (of program modules/applications 132). Application 200 configures processing unit 102 to provide GUI's to allow a field technician or other user to configure an EVPL 205 using a management system server 150. Computing device 100 communicates with management system server 150 using any communications path or paths 245, which may include wireless based internet access, cellular data internet access, etc. EVPL 205 can provide a dedicated connection between two UNIs or network interface devices (NIDs) 215 and 225, for example, or any other type of demarcation device that provides an access point for a recipient's networks or devices 210 and 220 (which may be terminal devices).

The EVPL 205 can be implemented using an Ethernet ring 235 having multiple nodes or switching devices 240. While three nodes are shown in the Ethernet ring 235, the Ethernet ring need not be limited to three nodes. Using the disclosed application 200 on the mobile computing device 100, a technician can configure the UNIs or NIDs 215 and 225 and the nodes or switching devices 240 of the Ethernet ring 235 via suitable communication paths 250 between management system server 150 and the various devices. Communication paths 250 can be LAN based communication paths, internet or intranet based communication paths, dedicated communication paths, wireless communication paths, etc.

The application 200 communicates with management server 150 via an application program interface (API) of the server to configure the network devices 210, 215, 220, 225, and 240. This configuration can be stored on the flash memory on the devices 210, 215, 220, 225, and 240. This configuration allows the service to work and data to pass from one endpoint to the other and for the ring failover to work in sub-50 ms failover.

Based on the values inputted into the application 200 by the application user, the application determines the API calls to be made and the values to be configured on the devices 210, 215, 220, 225, and 240. Once the configuration is complete, the application receives notification that the service is configured and the application is then able to provide a simple view of the configured service.

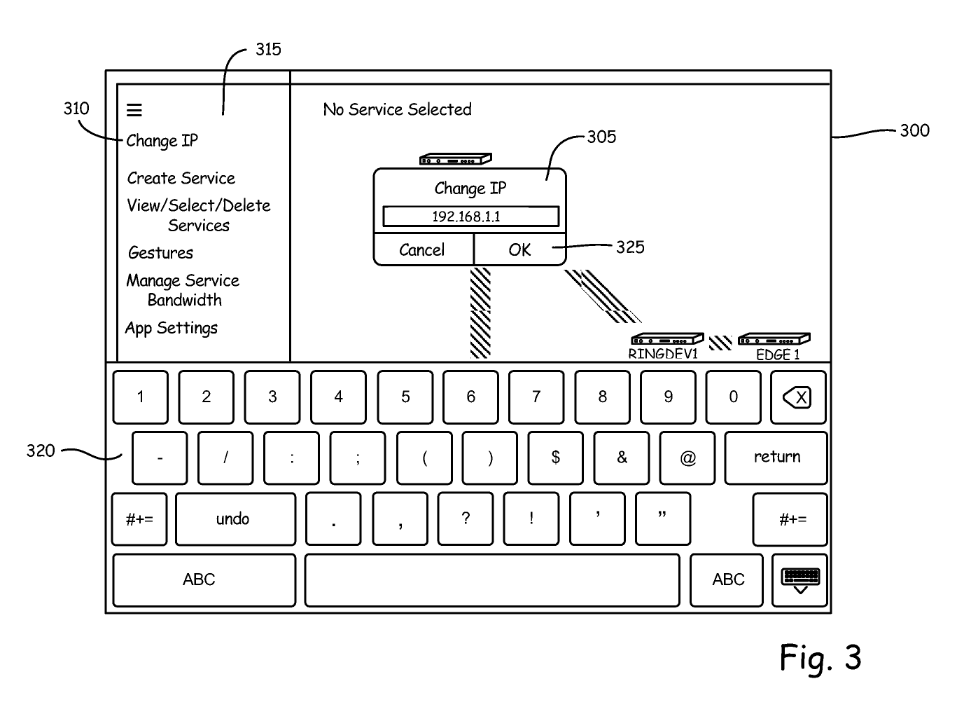

Referring now to FIG. 3, shown is a GUI screen 300 generated by application 200 (via its configuration of processing unit 102). As can be seen, the application includes, such as starts out with, a popup 305 that allows the user to enter the internet protocol (IP) address of the management system server 150. Also, at any point, the user can connect to a different management server by clicking on (e.g., to include touching) the “Change IP” input 310 on menu bar 315. A soft keyboard 320 is generated to allow the user to enter the IP address before selecting “OK” input 325.

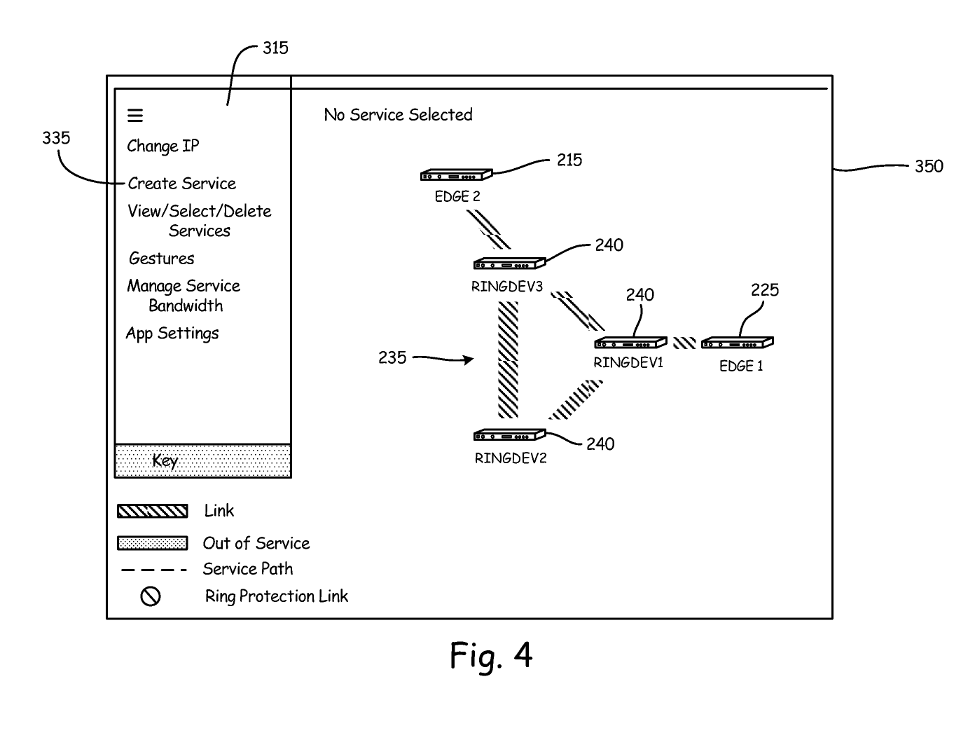

Referring next to FIG. 4, shown in GUI screen 350 which serves as the home screen where the user is shown the network topology of the devices on the network. The application 200 communicates with management system server 150 to get the information on which devices are in the network and how they are connected. The application 200 then displays the network as shown in the example of FIG. 4 in a very easy and intuitive layout.

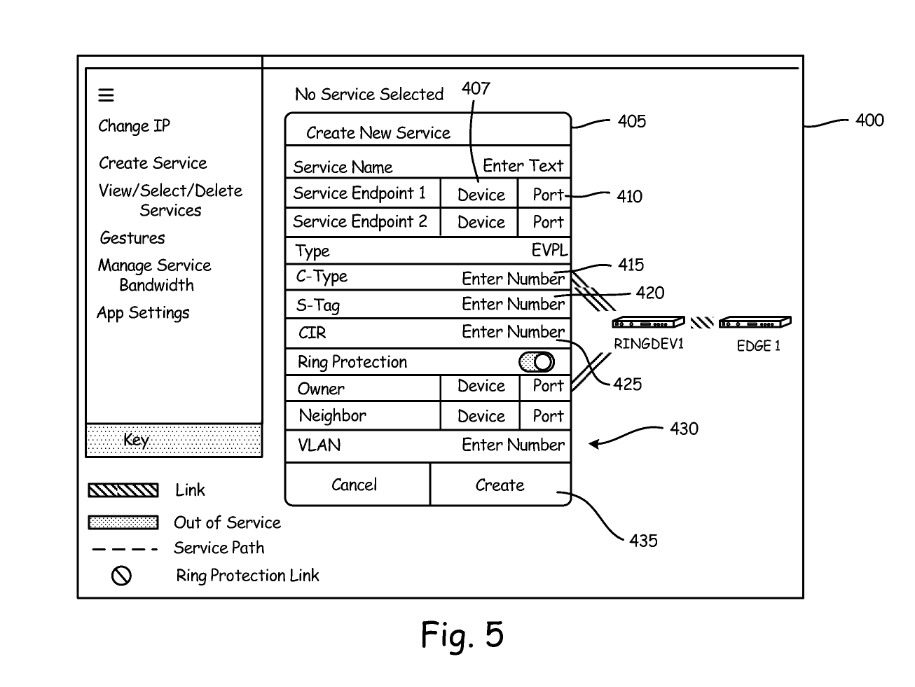

Clicking on the Create Service option input 355 of menu 315 brings up the “Create Service” popup menu 405 in GUI screen 400 shown in FIG. 5. The Create Service menu 405 allows the field technician to select the device from the graphical view which populates the name of the device in the field 407, the port on the device that is being used for the customer into input field 410, any tags on the customer traffic into input field 415, how much bandwidth the customer is purchasing into input field 425, and the service provider tag for that customer's traffic, which may be required to be entered into input field 420 to configure the service in some instances. For configuring the Ethernet Ring Protection switching for sub-50 ms failover, the field technician only needs to enter information about the link which will be the redundant link by providing the owner and neighbor information on that link into input fields 430.

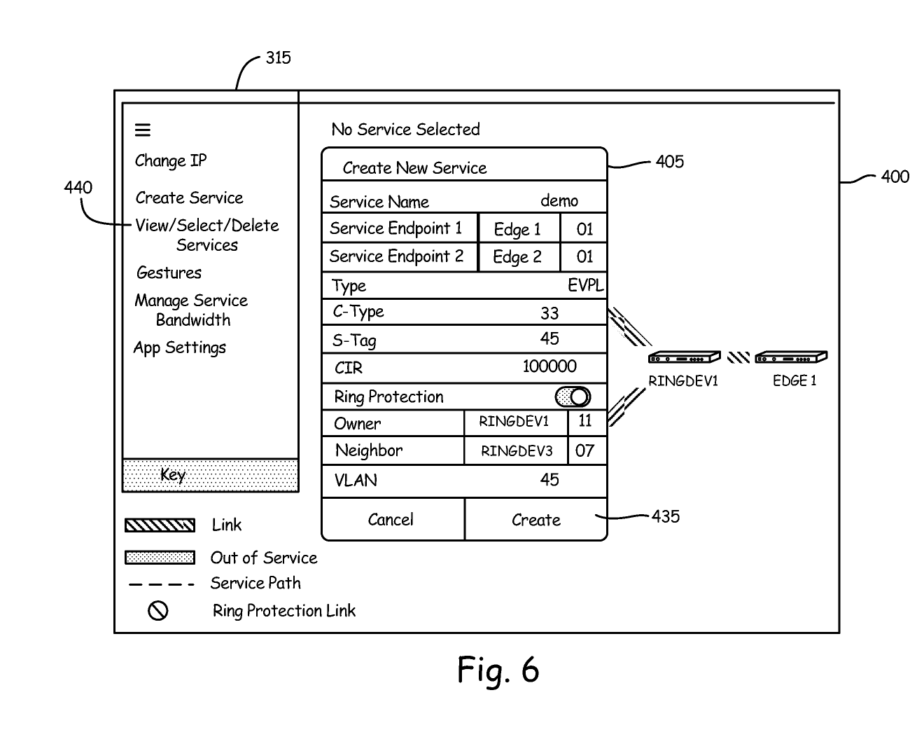

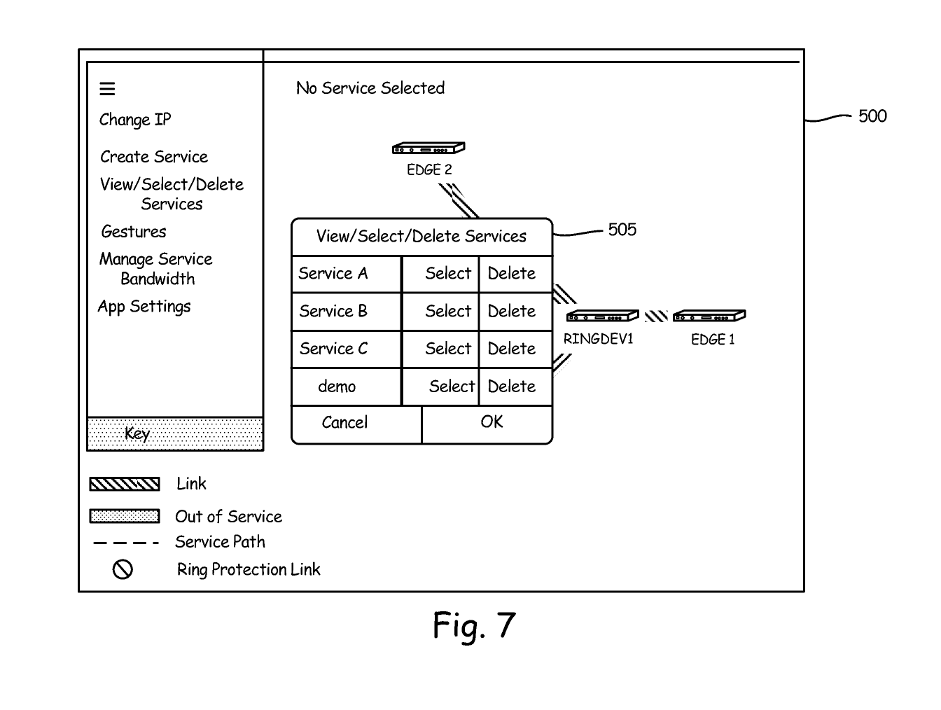

FIG. 6 illustrates GUI screen 400 with the input fields populated by the user. Once the fields are entered, the service can be created by clicking on the Create option input 435. The created service can then be viewed by selecting the View/Select/Delete Service option input 440 on menu 315, and selecting the service in popup menu 505 shown in the GUI screen 500 shown of FIG. 7.

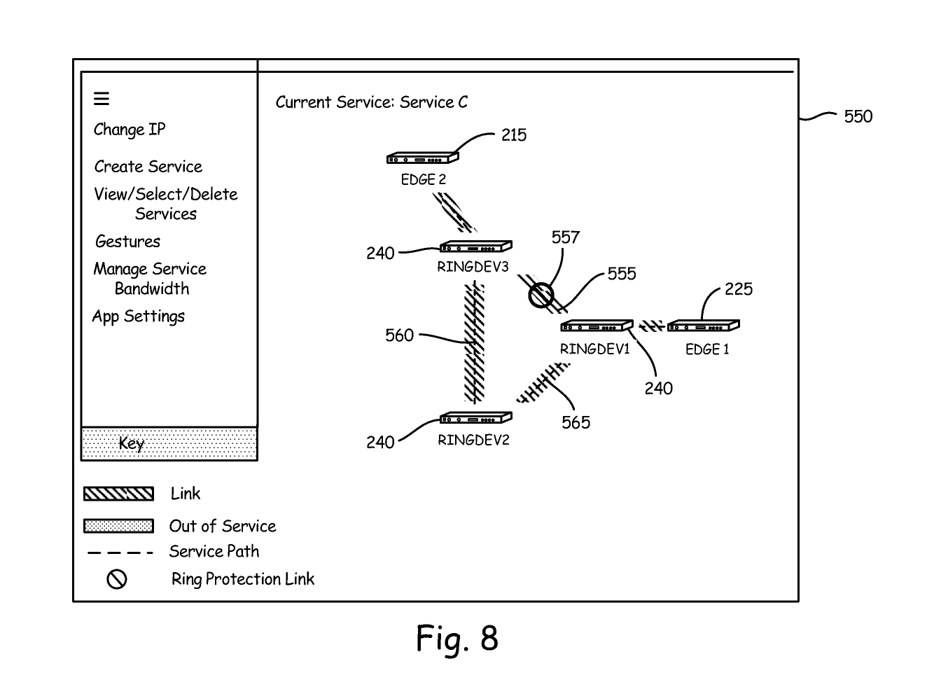

FIG. 8 illustrates a GUI screen 550 showing an example of a view of the created service. The view of the service shows that the traffic is moving on the path that is not blocked, including links 560 and 565. The blocked path or link 555 is clearly shown with a symbol 557, for example a red circle and a slash, and is labeled “Ring Protection Link (RPL)” for further identification by the user. Illustration of data traffic flow can be done in any graphical or other manner for the user's ease of understanding. For example, the paths 560 and 565 can be shown as dashed lines or in a different color than path 555, such as green, etc. In such an example, path 555 could be displayed as red, grey, etc. Green appears to be an intuitive color for an active link, and red appears to be an intuitive color for a failing link, for example; thus use of such coloring is not arbitrary and provides benefits to streamlining EVPL configurations.

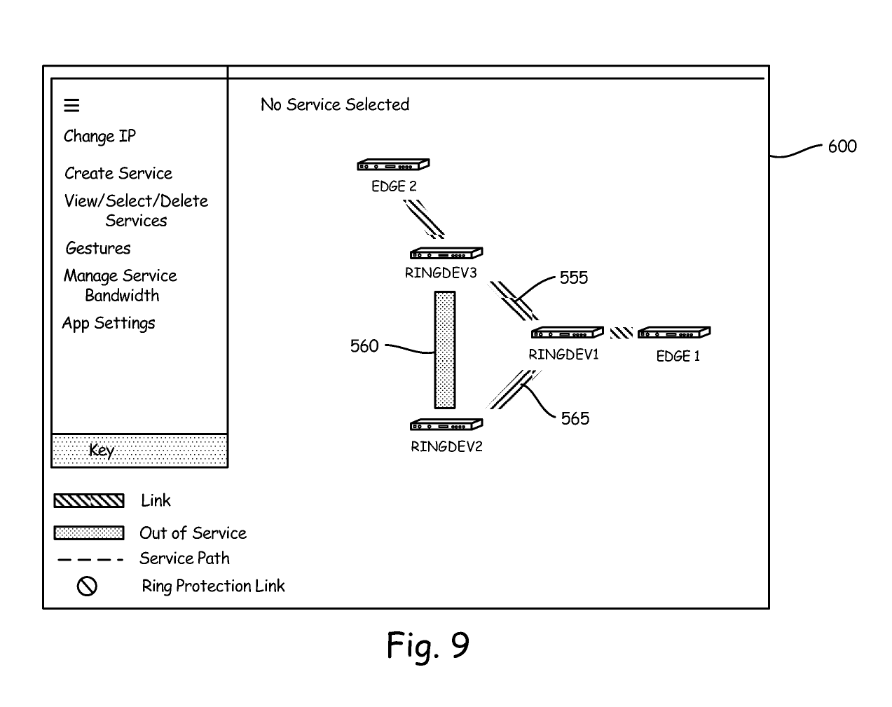

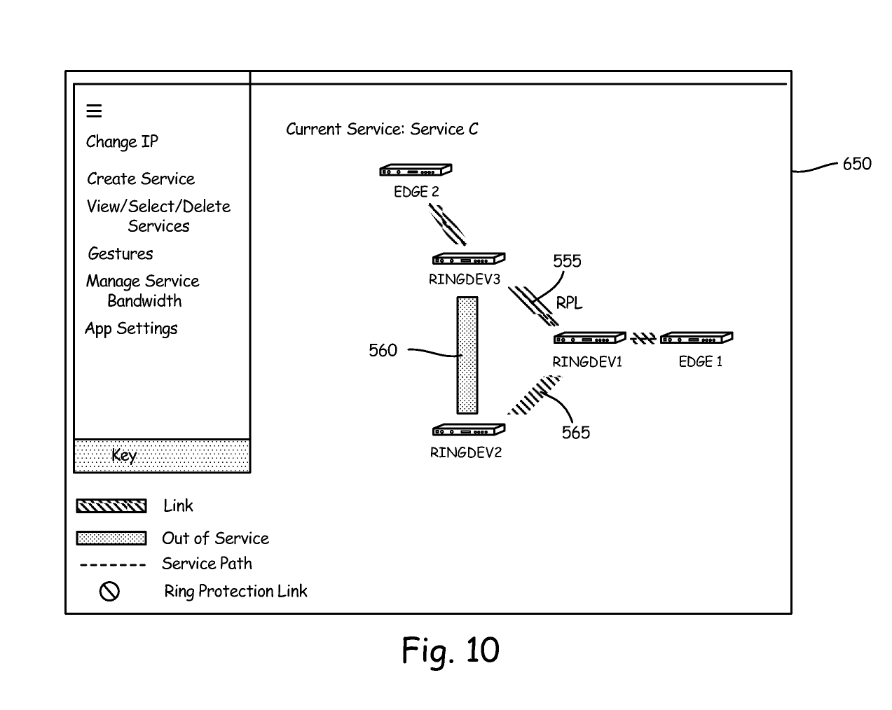

If a link on the active path fails, the application displays the failed link on the home screen as shown in the GUI screen 600 included in FIG. 9 in which link 560 has failed. The failure of a link can be shown by changing the color of the link or by other visual representations such as a pattern fill. As can be seen in FIG. 9, due to the failure of path 560, link 555 serves as the failover path and is no longer illustrated as being blocked and symbol 557 is no longer displayed. As shown in GUI screen 650 included at FIG. 10, when the user views a service with a link failure on the active path, flow of data traffic through the RPL 555 is clearly indicated, for example by both color coding, dashed lines, and a textual label.

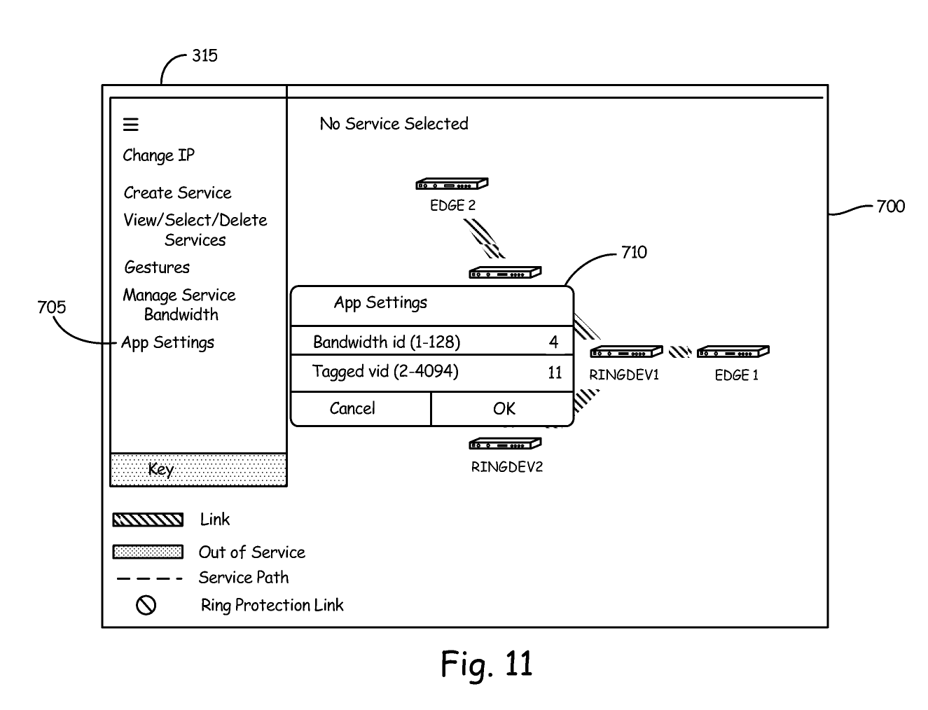

Referring now to FIG. 11, shown is a GUI screen 700 which is displayed after a user clicks on the “App Settings” input 705 of menu 315. A popup 710 is generated to allow the user to configure some defaults for the particular device 100.

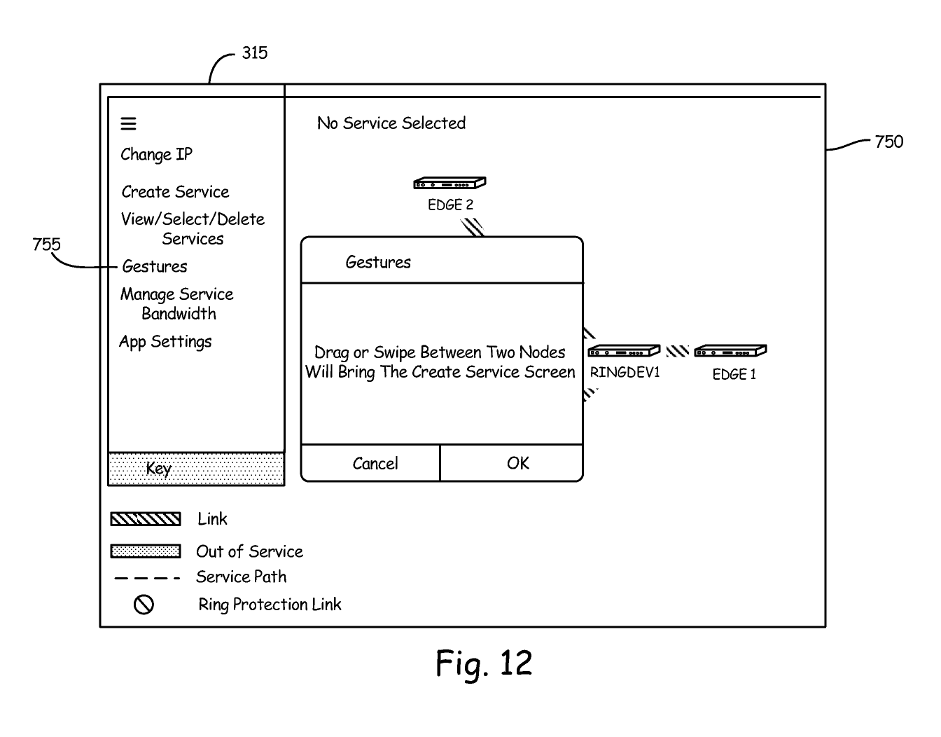

Referring now to FIG. 12, shown is a GUI screen 750 which is displayed when “Gestures” input 755 of menu 315 is clicked. Clicking on Gestures provides the user with a popup window containing information on how Gestures can be used to further simplify service creation. In some exemplary embodiments, the communication path between node devices 240 or between UNIs or NIDs 215 and 225 can be created by touching one device on the home screen and dragging or swiping the user's finger, stylus, or other mechanism for initiating a touch input to a second device on the home screen. This gesture causes the application 200 to automatically generate the Create New Service screen 400 and popup 405 with the device names prepopulated in the relevant input fields.

In some exemplary embodiments, gestures make this application as intuitive as possible. Learning a new interface can be made dramatically easier by incorporating gestures that are representative of how the human mind works. For a technician about to provision a service, dragging or swiping between the two edge devices is a very intuitive way to start the service creation process. Similarly, dragging or swiping along the link during the Ring Protection configuration process takes into account the way that a human would identify which link will be the Ring Protection link in order to make the application more intuitive and easy to use.

As shown in the depicted GUIs in FIGS. 3-12, many details in configuring an EVPL have been left out. For the most part, these other specifics, not included in the GUIs, may include values that change infrequently from one EVPL setup to another. The streamlining of these GUIs resolves many of the problems with EVPL configuration already described herein. For example, such streamlining reduces user error and increases the speed of setup, especially in the field.

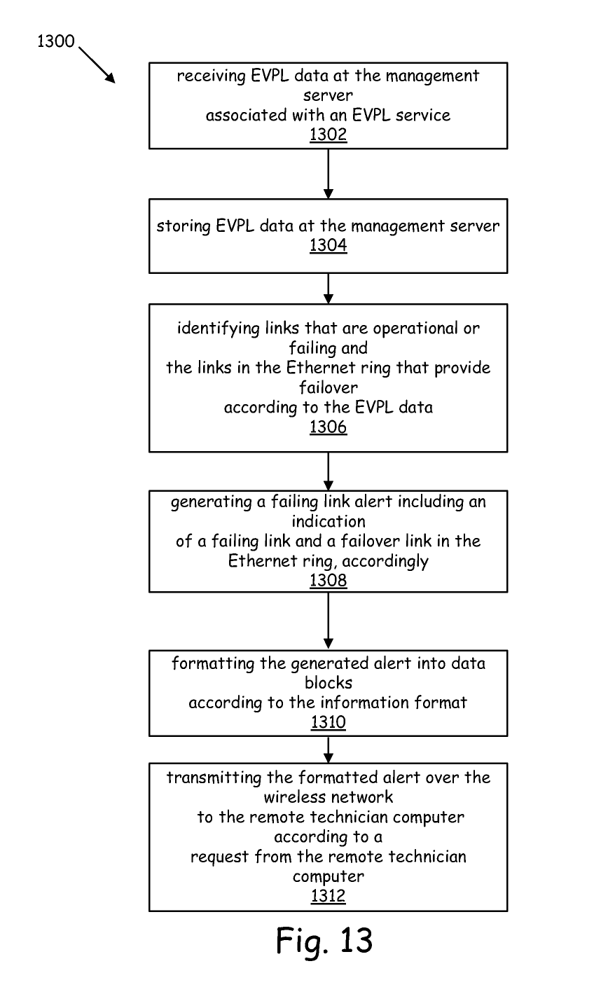

FIG. 13 illustrates example operations 1300 performable by the management system server 150 to control at least part of an EVPL viewer application installed on the remote technician computer (e.g., computing device 100), such as some operations mentioned above. The application may include a GUI that displays the view of the configured EVPL and a RPL. One problem with configuring an EVPL is the complexity caused by the topology of the Ethernet ring and demarcation devices associated with an EVPL. The complexity in the topology can be exacerbated by command-line user interfaces. The GUI described herein, provides a graphical layout of the topology of an EVPL making it easier for a technician to assess and understand the topology. Also, locations of failed links are much easier to identify through the GUIs described herein.

The RPL may be included in an Ethernet ring having at least three switch devices associated with the configured EVPL, and the RPL may include a failover link in the Ethernet ring that provides failover (such as failover including sub-50 ms failover). As mentioned herein, the management system server can be communicatively couple to the remote technician computer by a wireless network that includes Internet based communication paths, cellular based communication paths, or any combination thereof. Also, inferred herein, the remote technician computer may include a communicatively coupling to a wireless device configured to enable wireless communications over the wireless network with the management server according to at least an IP address of the management server.

The operations 1300 include receiving EVPL data at the management server sent from at least two demarcation devices of the EVPL linked to each other and the Ethernet ring over communication paths of a service providing network providing the EVPL, at 1302. In an example, the at least two demarcation devices can include a first UNI and a second UNI associated with the EVPL. In another example, the demarcation devices can include a first NID and a second NID associated with the EVPL. In yet another example, the demarcation devices can include a NID and a UNI associated with the EVPL. The service providing network can include local area network based communication paths, Internet or intranet based communication paths, dedicated communication paths, wireless communication paths, or any combination thereof.

In examples, such as some examples described herein, the EVPL data is configured such that the failover link provides the failover and private communications can occur between terminal devices communicatively coupled to the demarcation devices. Also, management system server 150 may include a processor and memory that stores the EVPL data, at 1304, which includes information format, operational status and network topology information of the demarcation devices and the at least three switch devices including which links in the Ethernet ring provide failover and which links are operational or failing. Mentioned herein, the demarcation devices can store respective EVPL data in respective flash memory devices of the demarcation devices.

The processor, with the stored data, can identify links that are operational or failing and the links in the Ethernet ring that provide failover according to the operational status and network topology information, at 1306. The processor can also generate a failing link alert including an indication of a failing link and a failover link in the Ethernet ring that is providing the failover due to the failed link, based on the identified links, at 1308. It can also format the generated alert into data blocks according to the information format, at 1310, and transmit the formatted alert over the wireless network to the remote technician computer according to a request from the remote technician computer 1312. In an example, the processor can transmit the formatted failing link alert over the wireless network to the remote technician computer according to an application program interface (API) of the management server and the request from the remote technician computer. The transmitted alert can activate the application to cause the alert to display on the remote technician computer.

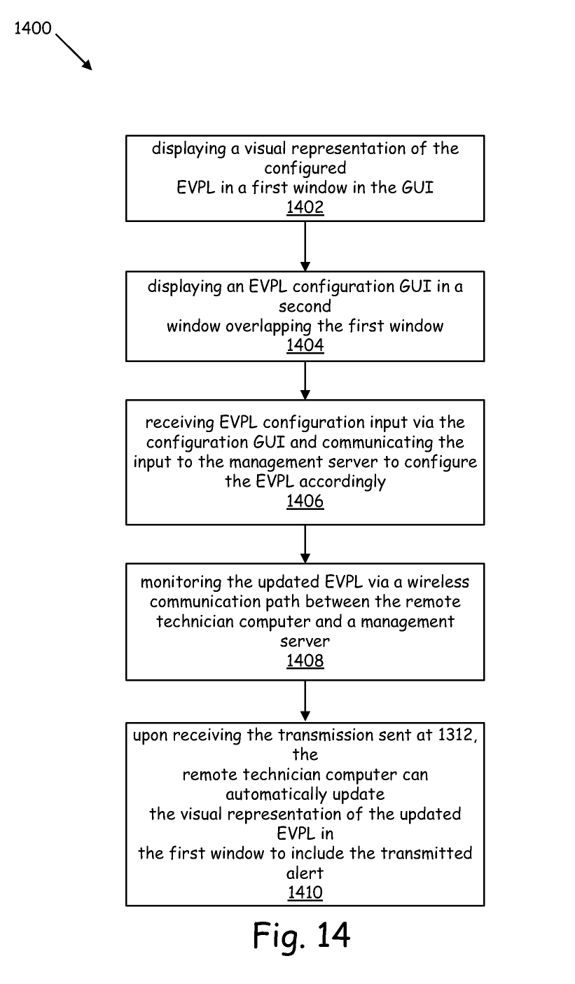

FIG. 14 illustrates example operations 1400 performable by the remote technician computer, such as mobile computing device 100, to provide an interactive view of a configured EVPL in a GUI of the remote technician computer, such as some operations mentioned above. The operations 1400 include displaying a visual representation of the configured EVPL in a first window in the GUI, at 1402. They also include displaying an EVPL configuration GUI in a second window overlapping the first window in the GUI such that at least part of the visual representation of the configured EVPL is visible, at 1404. Also, operations 1400 include receiving EVPL configuration input via the configuration GUI in the second window and communicating the input to the management server to configure the EVPL accordingly, at 1406.

Also, operations 1400 include monitoring the EVPL, updated by the configuration input, via a wireless communication path between the remote technician computer and a management server according to requests sent from the remote technician computer, when the remote technician computer is communicatively couple to the management server, at 1408. As inferred in examples herein, a request of the requests can include the EVPL configuration input and that input can be used by management system server 150 to update the EVPL data according to the EVPL configuration input such that the failover link provides the failover, and private communications can occur between terminal devices communicatively coupled to the demarcation devices. Also, the request may include an IP address of the management server, configuration information associated with the demarcation devices, and configuration information associated with the at least three switch devices.

The configuration information associated with the switch devices can include an indication of which of the switch devices are to be linked to provide failover. The indication of which of the switch devices are to be linked to provide failover can include a sensed gesture on a touchscreen communicatively coupled to the remote technician computer. The sensed gesture can include a swipe or drag between visual representations of the switch devices to be linked to provide failover.

Using sensed gestures can be beneficial with a touchscreen of a mobile device for a technician in the field. For example, one problem with setting up EVPLs in the field is that the technician is usually standing and not at a desk, so using a mouse or a keyboard is not an option. Also, in such mobile environments it can be much more difficult to enter linking data with a keypad than using a mere swipe or drag on the touchscreen between two displayed nodes. This type of user interaction is also beneficial in that a customer can visually experience and easily understand the configurations occurring through the touchscreen. Whereas, a technician configuring an EVPL through a command line provides little useful and understandable information to a customer viewing the configuration process, unless that customer has expertise in the field.

Referring back to FIG. 13, management system server 150 eventually transmits transmitting the alert over the wireless network to the remote technician computer according to the requests sent from the remote technician computer (such as shown at 1312 in FIG. 13). The request in this example includes the EVPL configuration input. Upon receiving the transmission, the remote technician computer can automatically update the visual representation of the updated EVPL in the first window to include the transmitted alert, at 1410.

Although the present invention has been described with reference to preferred embodiments, workers skilled in the art will recognize that changes may be made in form and detail without departing from the spirit and scope of the invention.

What is claimed is:

1. A method of providing an interactive view of a configured Ethernet Virtual Private Line (EVPL) over a wireless network to a remote technician computer, the method comprising:
controlling, at a management server, at least part of an EVPL viewer application installed on the remote technician computer, wherein the application includes a graphical user interface (GUI) that displays the view of the EVPL and an Ethernet ring associated with the EVPL;
receiving EVPL data at the management server sent from demarcation devices of the EVPL;
identifying links that are operational or failing and links in the Ethernet ring that provide failover, according to the EVPL data;
generating a failing link alert including an indication of a failing link and a failover link in the Ethernet ring, based on the identified links; and
transmitting the alert over the wireless network to the remote technician computer according to a request from the remote technician computer, wherein the transmitted alert activates the application to cause the alert to display on the remote technician computer.

2. The method of claim 1, wherein the EVPL data is configured such that the failover link provides the failover and private communications can occur between terminal devices communicatively coupled to the demarcation devices.

3. The method of claim 2, wherein the management server comprises: a processor that performs the identifying of the links and generating of the failing link alert, and memory that stores the EVPL data that includes operational status and network topology information of the demarcation devices and the Ethernet ring including which links in the Ethernet ring provide failover and which links are operational or failing.

4. The method of claim 1, wherein the demarcation devices of the EVPL are linked to each other and the Ethernet ring over communication paths of a service providing network providing the EVPL.

5. The method of claim 1, wherein the demarcation devices include a first user-network interface (UNI) and a second UNI associated with the EVPL.

6. The method of claim 1, wherein the demarcation devices include a first network interface device (NID) and a second NID associated with the EVPL.

7. The method of claim 1, wherein each of the demarcation devices stores its respective EVPL data in its respective flash memory device.

8. The method of claim 1, wherein the service providing network includes local area network based communication paths, Internet or intranet based communication paths, dedicated communication paths, wireless communication paths, or any combination thereof.

9. The method of claim 1, wherein the management server transmits the failing link alert over the wireless network to the remote technician computer according to an application program interface (API) of the management server and the request from the remote technician computer.

10. The method of claim 1, wherein the request includes an IP address of the management server.

11. The method of claim 1, wherein the request includes configuration information associated with the demarcation devices.

12. The method of claim 1, wherein the request includes configuration information associated with switch devices of the Ethernet ring.

13. The method of claim 12, wherein the configuration information associated with the switch devices includes an indication of which of the switch devices are to be linked to provide failover.

14. The method of claim 13, wherein the indication of which of the switch devices are to be linked to provide failover includes a sensed gesture on a touchscreen communicatively coupled to the remote technician computer.

15. The method of claim 14, wherein the sensed gesture includes a swipe, over the GUI, between visual representations of the switch devices to be linked to provide failover.

16. The method of claim 14, wherein the sensed gesture includes a drag, over the GUI, between visual representations of the switch devices to be linked to provide failover.

17. A computer-implemented method for providing an interactive view of a configured Ethernet Virtual Private Line (EVPL) in a graphical user interface (GUI) of a remote technician computer, the method comprising:
displaying, by the remote computer, a visual representation of the EVPL in the GUI;
displaying an EVPL configuration interface in the GUI;
receiving EVPL configuration input via the displayed configuration interface;
monitoring, by the remote computer, the EVPL via a management server, according to requests it sends to the management server, wherein the requests include the EVPL configuration input;
receiving, by the remote computer, a failing link alert transmitted from the management server, wherein the alert is based on status of aspects of the EVPL and the EVPL configuration input; and
automatically updating the visual representation of the EVPL to include the received alert.

18. The method of claim 17, wherein the visual representation of the EVPL includes visual representations of aspects associated with the EVPL, including an Ethernet ring, demarcation devices, and a failover link in the Ethernet ring.

19. A system useful to a service provider serving an interactive view of a configured Ethernet Virtual Private Line (EVPL) over a wireless network to a remote technician computer, the system comprising:
a computer store containing EVPL data, for the EVPL, defining operational status and network topology information associated with the EVPL, which links in an Ethernet ring associated with the EVPL provide failover, and which links in the EVPL are operational or failing; and
a computer server at the service provider, wherein the computer server is communicatively coupled to the computer store and programmed to:
receive EVPL data from the computer store; and
control at least part of an EVPL viewer application installed on the remote technician computer, wherein the application includes a graphical user interface (GUI) that displays a view of the EVPL and the Ethernet ring, and wherein the control of the least part of the EVPL viewer application includes:
identifying links that are operational or failing and the links in the Ethernet ring that provide failover;
generating a failing link alert including an indication of a failing link and a failover link in the Ethernet ring, based on the identified links; and
transmitting the alert over the wireless network to the remote technician computer according to a request from the remote technician computer.

20. The system of claim 19, wherein the request from the remote technician computer includes configuration information associated with switch devices of the Ethernet ring and an indication of which of the switch devices are to be linked to provide failover, and wherein the indication of which of the switch devices are to be linked to provide failover includes a sensed gesture on a touchscreen communicatively coupled to the remote technician computer.
